(19) United States
(12) Patent Application Publication
(10) Pub. No.: US 2017/0001120 A1
(43) Pub. Date: Jan. 5, 2017

(54) SYSTEM AND METHOD FOR OPERATING A FANTASY SPORTS LEAGUE

(71) Applicant: John Mueller, Leawood, KS (US)

(72) Inventor: John Mueller, Leawood, KS (US)

(21) Appl. No.: 15/178,489

(22) Filed: Jun. 9, 2016

Related U.S. Application Data
(60) Provisional application No. 62/172,999, filed on Jun. 9, 2015.

(51) Int. Cl. A63F 13/65; A63F 13/35; A63F 13/335; A63F 13/828; G07F 17/32

(52) U.S. Cl. CPC A63F 13/65; A63F 13/828; G07F 17/3244; A63F 13/335; A63F 13/35; G07F 17/3279; G07F 17/3276; G07F 17/3288; A63F 2300/8052; A63F 2300/407

(57) ABSTRACT

A method and system is disclosed for operating a fantasy sports league independent of actual game-based time keeping or actual game-based segmenting such as innings, quarters, periods, halves, etc. The method includes storing, in a computer database, statistical performance data for a set of real-world athletes, time-stamping each statistic or player performance metric at a time the statistic or player performance metric was monitored, defining qualifying statistics and player performance metrics for accrual into a fantasy sports point system based upon the time-stamp associated with the statistic and player performance metric, and scoring the fantasy league based upon a user defined time range.

### CROSS REFERENCE TO RELATED APPLICATIONS

This application claims the benefit of U.S. Provisional Patent Application No. 62/172,999, filed Jun. 9, 2015, and incorporated herein by reference in its entirety.

### TECHNICAL FIELD

This disclosure relates generally to fantasy sports games, and more particularly to systems and methods for fantasy sports-based games having user-defined game times.

### BACKGROUND

The statements in this section merely provide background information related to the present disclosure and may not constitute prior art.

In known online fantasy sports games, such as fantasy football, baseball, hockey, golf, and automobile racing, a user can create a fantasy team that includes a plurality of fantasy players. Often the fantasy players are based upon real-life players. An online fantasy sports game typically includes a player selection phase, i.e., a “draft” followed by a game play phase. The user's fantasy team may then compete against fantasy teams of other users or various computer generated teams.

The users may access the fantasy sports games via a computer-based interface, such as a web site using, e.g., a web browser. In the games, each fantasy player corresponds to a real-life sports player having the same name and statistics as a real-life sports player. Game play usually includes a user choosing a limited number of players for a team with the goal of creating a team that will score the most points. The statistics used in a fantasy league vary among leagues and may include an average number of points scored per game and other statistical measures of performance based upon league rules.

The player selection phase often occurs before real-life games and/or between sports seasons, and the game play phase occurs during a season or series of real-life games. The game play phase is typically real-time and occurs on game days, which are days on which real-life sports games are played. Statistics of players in the real-life games, such as points scored by each of the players, are used to determine scores of the user's fantasy team and therefore the winners of the online fantasy games.

Known fantasy leagues are all similar in that actual statistics entire games are used for game play. That is, all known fantasy games specify seasons in terms of a number of actual games such as in a series, specify the season as corresponding to an actual sports season, or specify the season in terms of days, e.g., 5 day fantasy league. Therefore, it would be advantageous for a new fantasy game wherein statistics may be used that are independent of actual game segmenting or based upon a date parameter.

### SUMMARY

Method and system is disclosed for operating a fantasy sports league. The method includes storing, in a computer database, statistical performance data for a set of real-world athletes, time-stamping each statistic or player performance metric at a time the statistic or player performance metric was monitored, defining qualifying statistics and player performance metrics for accrual into a fantasy sports point system based upon the time-stamp associated with the statistic and player performance metric, and scoring a fantasy league based upon a time range. Certain embodiments of the disclosure include the ability for floating wagering.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a block diagram of a user computer communicating with a server computer over a network, in accordance with an embodiment of the present disclosure;

FIG. 2 is a flowchart of an exemplary process for operating a fantasy league, in accordance with an embodiment of the present disclosure;

FIG. 3 is a diagram depicting exemplary data as it relates to a user defined period and actual game segments, in accordance with an embodiment of the present disclosure; and

FIGS. 4-17 show various exemplary user interfaces for administering and participating in a fantasy sports league for a kiosk, in accordance with an embodiment of the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The disclosure herein is described with reference to block diagrams and operational illustrations of methods and devices to select and present media related to a specific topic. It is understood that each block of the block diagrams or operational illustrations, and combinations of blocks in the block diagrams or operational illustrations, can be implemented using hardware and computer program instructions, e.g., software. These computer program instructions can be provided to a processor of a general purpose computer, mobile computing device, special purpose computer, or other programmable data processing apparatus, such that the instructions, which execute via the processor of the computer or other programmable data processing apparatus, implements the functions/acts specified in the block diagrams or operational block or blocks.

In some alternate implementations, the functions indicated in the blocks can occur out of the order indicated in the operational illustrations. For example, two blocks shown in succession can in fact be executed substantially concurrently or the blocks can sometimes be executed in the reverse order, depending upon the functionality involved. Furthermore, the embodiments of methods presented and described as flowcharts in this disclosure are provided as exemplary to provide a more complete understanding of the technology. As such, it is not intended that the disclosed methods are limited to the operations and logical flow presented herein excepted as specified in the appending claims. Alternative embodiments are contemplated in which the order of the various operations is altered and in which sub-operations described as being part of a larger operation may be performed independently.

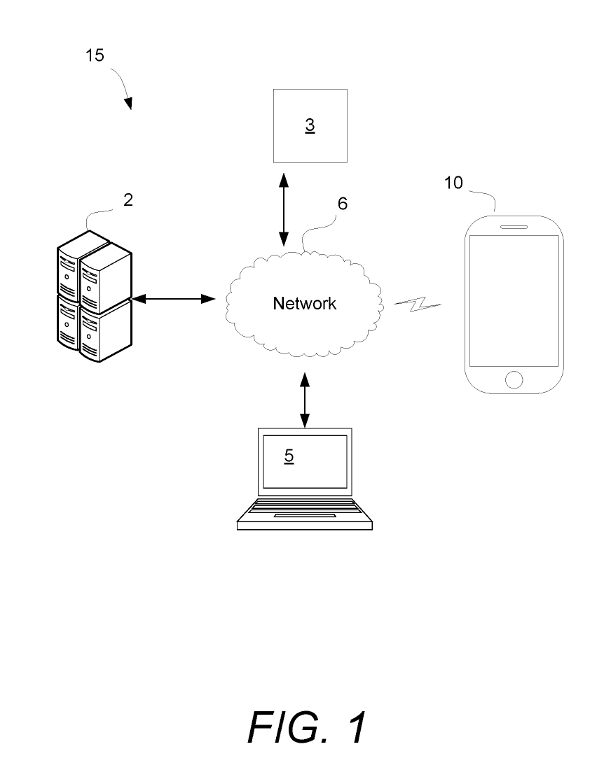

FIG. 1 is a block diagram of an exemplary fantasy sports system 15 of a client-computer 10 communicating with an admin-server 2 that can be utilized to provide user access to one or more fantasy sports applications and/or functions. The sever 2 would generate and/or serve web pages, for example, to be displayed by a browser of client-computer 10 or kiosk 5 over a network 6 such as the Internet. In one embodiment, an owner of a fantasy sports team uses the client-computer 10 or kiosk 5 to manage his or her fantasy sports team roster. In one embodiment, the system includes a statistical data subscription server 3 communicatively connected directly to the server 2 or through the network 6.

The statistical data subscription server 3 is configured to provide real-time statistical information on the play of the real life game or sporting event including actual player statistics. In one embodiment, the statistical data subscription server 3 may be operated by a 3rd party subscription service. As used herein, “statistics” encompasses any identifiable, measurable, monitored metric and/or recorded value accrued by a player's performance in the player's actual sport. For example, a player's statistics in basketball may include (but are not limited to) one or more of the number of shots taken, number of minutes played, and defensive rushes (if this statistic is kept and recorded). It would be understood to one of ordinary skill in the art that each sport includes preferred or commonly used statistics in that sport including advanced statistics. For example, for baseball, common statistics may include batting average, home runs, runs batted in (RBI), runs, hits, earned run average (ERA), walks plus hits per innings pitched (WHIP), strikeouts, wins, and saves.

Statistics are calculated, input, or provided by a database from the server 3 either manually or preferably automatically and/or electronically, i.e., by computer or similar processing device such as the server 3. Electronically includes, but is not limited to computer, Internet, or other suitable electronic processing such as the network 6. Updating can occur continuously, dynamically, at preset time intervals, upon request by the fantasy league commissioner, or upon request by the manager of a particular fantasy team.

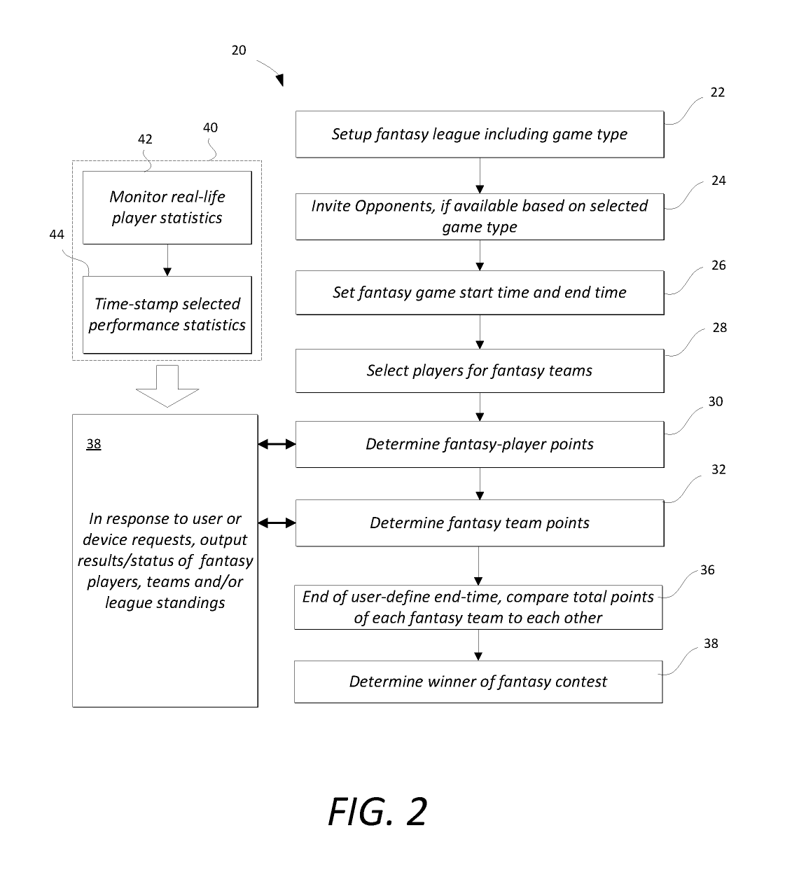

FIG. 2 is a flowchart of an exemplary process 20 performed by the sever computer 2 during operation. The process 20 is initiated at step 22 whereby a league manager, i.e., league commissioner, or system administrator initializes a fantasy league for a selected or predefined sport having players capably or measurable performance statistics. In one embodiment, the fantasy league may be initialized on a kiosk 5 so that fantasy players may manage their sports teams on their mobile devices such as the one or more of the client-computers 10.

In one embodiment, the system 15, concurrent to the any number of processes 20, executes processes 40 for monitoring real life player statistics 42 for association with a time-stamp 44 and storage into a database residing on the server 2 or communicatively connected to the server 2. In one embodiment, player statistics are received by the server 2 and/or database and then time-stamped for storage. In one embodiment, the statistics and performance metrics are time-stamped in UTC format.

In one embodiment, statistics and performance metrics are received and associated with a time that corresponds to a game time, i.e., a game clock time format. For example, a touchdown was scored with seven minutes 33 sections left to play before the half. Knowing the UTC game start time, these statistical and performance metrics can then be associated with a UTC time that corresponds to the time received in the game clock time format. In one embodiment, a fantasy league start time may be used as a baseline for association with current game statistics and performance metrics. Statistics and performance metrics time stamped before the start time are disregarded or subtracted, as appropriate, to statistics and performance metrics associated with the active time of the fantasy game. At various times during play, a user may request current league standings, team fantasy points, or player fantasy points 39.

It is contemplated herein that any number of fantasy leagues can be created for a selected sport for administering by the server 2. Each fantasy league can include one or more fantasy teams managed by an owner. Each team includes at least one player. At setup, the league commissioner must select a game type. For example, game type can include single players or multi-player in head-to-head style, rotisserie, or tournament. Various embodiments contemplate computer simulations as potential fantasy players. The league commissioner must also select an actual sport from a provided selection list, e.g., baseball, football, etc.

At step 24, the system 15 receives selection of a sport, game-type from the league commissioner and the system 15 then requests input related to the number of fantasy player-participants for invitation to the new fantasy league. In various embodiments, the commissioner may select a computer simulation as an opponent. If a head-to-head style, multiplayer, or tournament style is selected, the commissioner may send an invitation to the users to join the fantasy league. If tournament game type is selected, a fantasy season is setup where the players compete in one or more contests. A tournament may be setup where each owner plays every other owner in separate contests, each contest being associated with a selected game(s).

At step 26, the league commissioner specifies a start and end time. In one embodiment, the league commissioner may specify a start time and a duration so an end time may be determined. It is contemplated herein that the start time may be specified using an hour and a minute parameter. In one embodiment, a seconds parameter may be used. In one embodiment, a current date is used as a default date. In one embodiment, a commissioner may change the date parameter so that the start date occurs at a specified date at a future date. The start time and duration or the start time and end time may be set independent of any actual game segmentation. For example, a start time may be set that occurs after a start time of the actual games, in the middle of an inning, in the middle of a quarter, etc. in this way, statistics used to determine fantasy points and fantasy game play are only used if the statistics or player performance metrics occur or are determined after the start time and before the end time. While the duration of the game may be limited, as used herein fantasy sports season may refer to such a time-limited fantasy game. In one embodiment, start time and end time may be selected or specified in Coordinated Universal Time (UTC) format or non-UTC format for conversion to UTC format.

At step 28, the player-owners select players for their fantasy teams. In one embodiment, the selections may be made irrespective of other player's selections. For example, each player may select actual player X. In various embodiments, the players can be selected, e.g., using a draft system, a lottery system, or an auto draft system. In the draft system, the fantasy team owners are placed in a numerical order. The fantasy team owners sequentially select players in that numerical order, e.g., the fantasy team owner first in the order selects the first player, the fantasy team owner second in the order selects the second player, etc. In the lottery system, each fantasy team owner is allotted a particular amount of credits, and each player is given a particular value in credits. The fantasy team owners fill their teams by exchanging credits for the players. In the auto draft system, players may be assigned to each fantasy team based on a predetermined value. It is contemplated herein that any number of processes may be used to select players, such as randomly.

In one embodiment, before player selection, the system 15 determines whether actual players are in an active state or whether they will be in an active state during the specified time range of the fantasy league, e.g., between the specified start and end times. In this way, players that are not likely to play or to accumulate fantasy points during the duration of the fantasy league are not presented for selection. Accordingly, players may be associated with one or more categories including (1) currently engaged in an active game; (2) will be engaged in an active game; (3) not associated nor expected to be associated with an active game.

In one embodiment, the fantasy team owners may select their active rosters, from among their respective players, i.e., the fantasy players who will compete in each fantasy game or fantasy series. Selection of active roster players may be executed in accordance with predetermined league rules. This selection process of “starters” and “reserves” is generally known in the art, although it is contemplated herein that a fantasy league may be setup so that there are no reserve players. For example, each selected player is “active” and able to accumulate fantasy points.

In various embodiments, the fantasy players must be selected based upon associated designated player positions, e.g., fullback, shortstop, pitcher, etc. For example, league rules may specify that an active roster cannot have more than one player from each position in the game, i.e., two players associated with the shortstop position may not be selected. In other embodiments, active roster may be filled irrespective of: (1) player position; and/or (2) the number of players allowed in a real game, e.g., nine players for baseball. For example, in one embodiment, a fantasy owner may select seven tight ends, having no requirement for filing specific real world athletic positions to compete. In one embodiment, for example, a fantasy owner may put 13 active players on a roster in a baseball league. A fantasy owner's opponent(s) can select an equal number of players. In various embodiments one or more athletic position rules may be instituted. For example league rules may specify that only one quarterback must be selected.

At step 30, subsequent to the start time, the system 15 computes player fantasy points based upon each actual player's real-life statistics and performance metrics and a time-stamp associated with the statistics and performance metrics. In various embodiments, the actual statistics from the real games participated in by a real-life player corresponding to each fantasy player are used in a play of the fantasy sport provided a time associated with the actual statistics is within the start and end time. Fantasy player points may be determined using any one of a number of fantasy sports games such as rotisserie-based scoring, provided that the statistics used occurred within the start and end times.

At step 32, the system 15 determines fantasy team points based upon the determined fantasy player points. In one embodiment, each of the fantasy player points from a player-owner's fantasy team is added to determine the fantasy team points. If the game type is a tournament type fantasy league, the system 15 will determine a winner of a contest and award a point toward league standings. Upon conclusion of a contest, a player-owner may be directed to select a new set of fantasy players for their fantasy team for an upcoming contest. The selection of fantasy players may be executed in accordance with predetermined league rules. A fantasy owner's opponent(s) can select an equal number of players. The league continues until there is a winner of the tournament and/or the number of specified contests has occurred.

At step 36, the total points or totaled statistics of the fantasy teams of a fantasy league are compared. Comparison may simply comprise sorting of the fantasy teams according to ascending or descending point totals. If a tournament style contest, then all contests have concluded at this step.

At step 38, the end time is reached, the fantasy season has concluded and a winner is then determined based upon the comparing. For each comparison, the fantasy team with the best statistics or the most points wins. Alternately, the team having the fewest number of points wins, where, for example, the fewest points corresponds to a better performing team, such as in the sport of golf. Once the winning and losing teams for each fantasy game or fantasy series are determined, the results for each team may be displayed, stored, or communicated.

Steps 26 through 36 may be repeated for each fantasy game or fantasy series occurring during the fantasy season. When the fantasy season concludes, in Step 38 the total statistics or the total points of each fantasy team for the fantasy season are determined. The results may be output, communicated and/or stored to a storage medium.

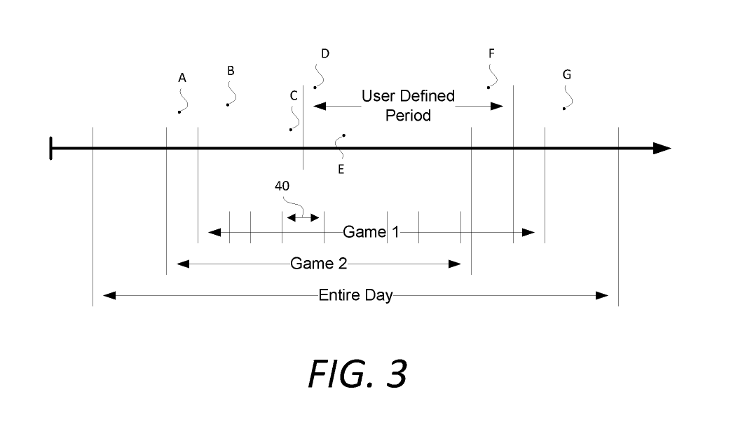

FIG. 3 is a diagram depicting exemplary data as it relates to a user defined period and actual game segments. FIG. 3 shows a plurality of exemplary statistical and performance metrics data points A to G correlated to a time parameter, a user defined period, a time period associated with game 1, a time period associated with game 2 plotted against a time range associated with an entire day. Time period 40 is associated with a game segment. As FIG. 3 shows, data points A, B, C, and G are outside of a time range associated with the user defined period. Data points D, E, and F, are within the user defined period. Hence data points D, E, and F would contribute to scoring in the fantasy game, while data points A, B, C, and G would not. Data point C and D are both within a particular game segment 40, which may be an inning or quarter, for example, but only data point D would contribute to scoring in the fantasy game.

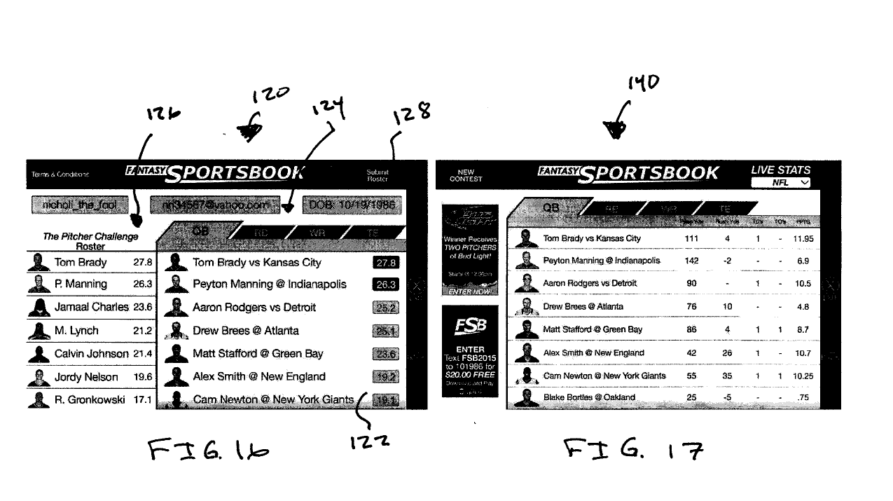

FIGS. 4-17 show various exemplary user interfaces for administering and participating in a fantasy sports league. The exemplary user interfaces are adapted to a mobile device and a system whereby participation among fantasy-players may be executed on a kiosk 5 and/or multiple mobile devices 10, e.g., each fantasy-player may have and use their own mobile device to participate. One skilled in the art, however, will readily recognize upon a careful reading of the teachings herein, that the interfaces may be adapted for play on a single device such as a kiosk or a desktop computing environment, for example. Further, use and display of projected fantasy points is an optional embodiment and shown and described herein as exemplary.

FIG. 4 shows an exemplary home navigational graphical interface 40 for a player-user, i.e., a potential fantasy team owner or fantasy league commissioner. As FIG. 4 shows, the player-user may select from a plurality of navigational icons including a new contest icon 50, a public contest icon 100, and a live stats icon 150. In one embodiment, an advertisement 42 may be included in the interface 40. The advertisement may be linked to a public contest as described herein below.

FIG. 5 shows an exemplary user interface 52 that may be navigated to by actuating the new contest icon 50. As FIG. 5 shows, a commissioner may set up a new contest by selecting from one of a number of fantasy sports 54. In one embodiment, the commissioner selects from a predefined time period 56 for playing the fantasy game. In one embodiment, the commissioner may supply a user time period. A field 58 may be provided so that the commissioner may name the league and/or name his/her fantasy team. In one embodiment, the interface 52 includes control features 51 and 55, and a navigational window 53 so that commissioner functioning as a fantasy player in addition to a commissioner role, my view fantasy players and select players for a fantasy team. As FIG. 5 shows, in one exemplary embodiment of a football fantasy sports league a plurality of fantasy players are displayed in a window 53 for selection by the user. The user may utilize tabs 51 to navigate among fantasy players. The tabs 51 may be categorized according to player position, although in various embodiments there is no requirement that a user select fantasy player based upon sports positions, e.g., one quarterback, one running back, etc.

As FIG. 6 shows, the user has selected fantasy players for a roster within the interface 52. As FIG. 6 shows, a projected fantasy point value 60 may be displayed proximate to the associated fantasy player, e.g., player 62. Selections may be dynamically displayed as made by the player-user, shown as named players under the roster column 63. In one exemplary fantasy game, fantasy player selections must be made corresponding to actual game positions, e.g., a player-user must select two quarterbacks, two running backs, two wide receivers, and a tight end, however embodiments whereby selections may be made independent of player position are contemplated herein.

FIG. 7 shows the interface 52 wherein the roster 63 contains a completed list of fantasy players for the player-user. Upon making the prerequisite number of selections, a pop up or other submission-based actuation button 62 may be presented so that the player-user may submit the selections and select an opponent or, in the kiosk embodiment, navigate to an interface for another player-user's fantasy player selections.

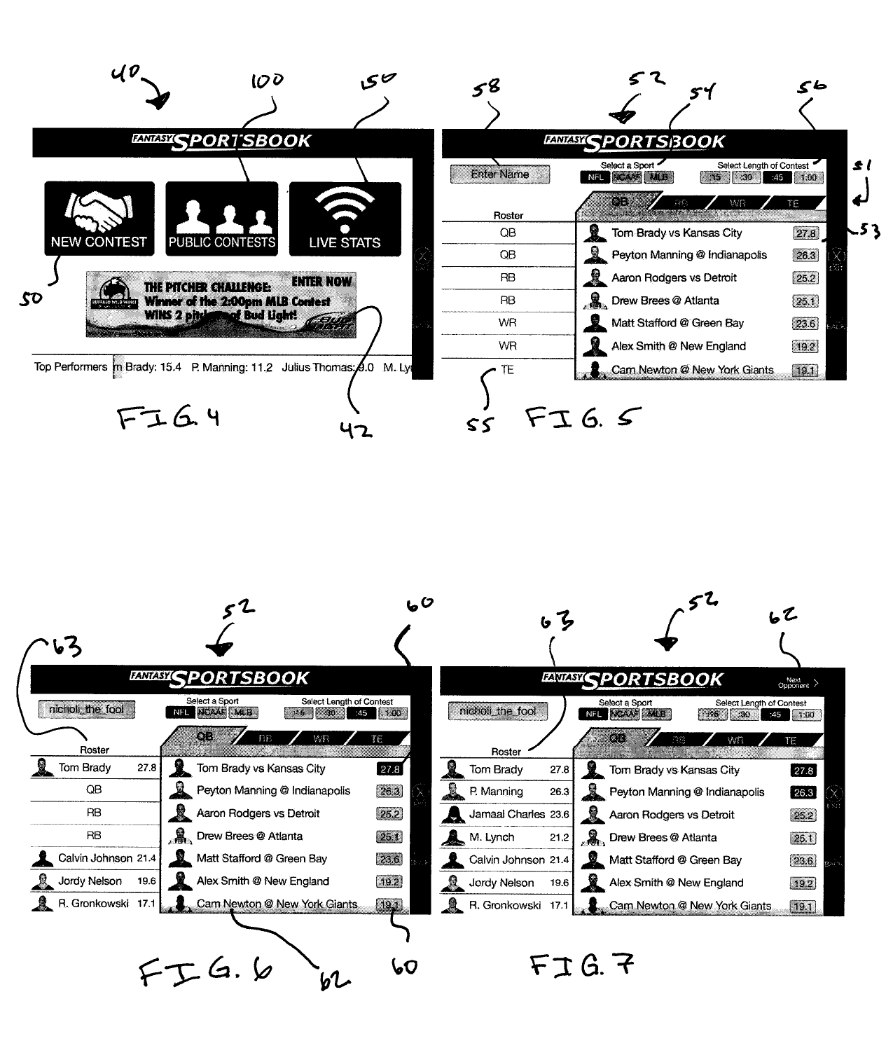

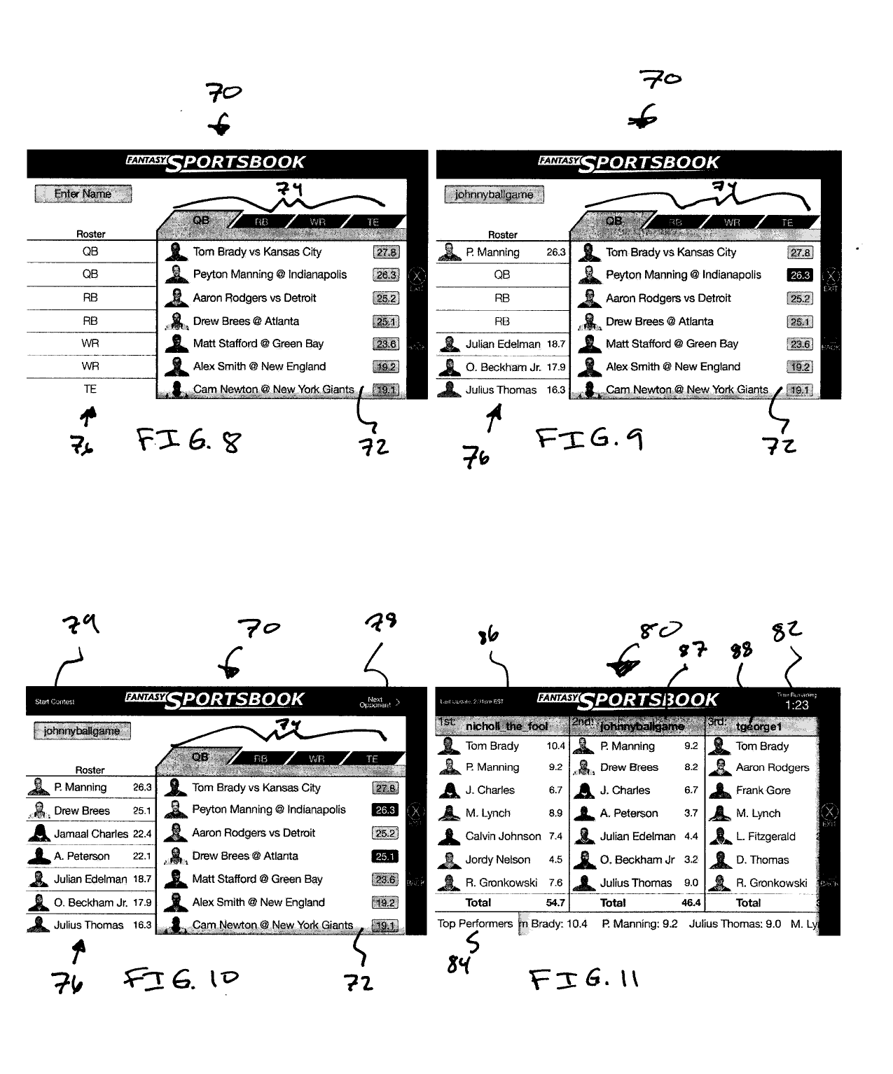

FIGS. 8-10 show an interface 70 configured to accept player selections for player-users who have not initiated the fantasy game. For example, in one embodiment whereby a commissioner first sets up the league and/or contest decisions about game play are not shown to subsequent player users. As FIGS. 8-10 show, subsequent player-user may select fantasy players from a navigational window 72 having a plurality of selectable fantasy players. Tabs 74 may be available to assist fantasy player selection and to help navigate among categories of fantasy players, e.g., by position. Similar to above selection by the commissioner, the player-user must select a predefined quantity of fantasy players for a roster 76. As above, the roster 76 may function according to predefined game-play such as position-based selection criteria, e.g., a player-user must select one quarterback. Upon completing a full roster such as shown in FIG. 10, a user may actuate a control button 78 so that another player-user may make selections for another fantasy team or actuate a start contest button 79 that begins the fantasy game.

FIG. 11 shows an exemplary user interface 80 displayed to the player-users upon start of a fantasy game. As FIG. 11 shows, the exemplary interface 80 shows selected fantasy players for each of the player-users 86, 87, and 88. The interface includes a countdown clock 82 that displays time remaining in the fantasy game contest. In one embodiment, fantasy scores associated with a fantasy player are displayed proximate to the fantasy player listing. A total fantasy points score may be displayed, wherein the total fantasy points score corresponds to a player-user's score for his/her fantasy team. In one embodiment, statistical information may be displayed in a module for infotainment purposes, e.g., a top performers scrolling board 84.

FIG. 12 shows an exemplary user interface 90 displayed to the player-users upon completion of a fantasy game contest, e.g., at the expiration of the countdown clock. The interface 90 shows final scores and rankings of the player-users, e.g., 1^{st} place, 2^{nd}, place, etc. In one embodiment, an actuation button 92 is available so that the players may have a rematch. Upon actuation of the button 92, the player-users may be direct to an interface for selecting players such as the interface 70 shown as exemplary in FIG. 8. In one embodiment, an actuation button 94 is available so that the player users may set up a new contest, e.g., with a new user defined time period, new sports, new players, etc. upon actuation of the button 94, the player-users may be direct to an interface for setting up the new contest such as the interface 52 shown as exemplary in FIG. 5.

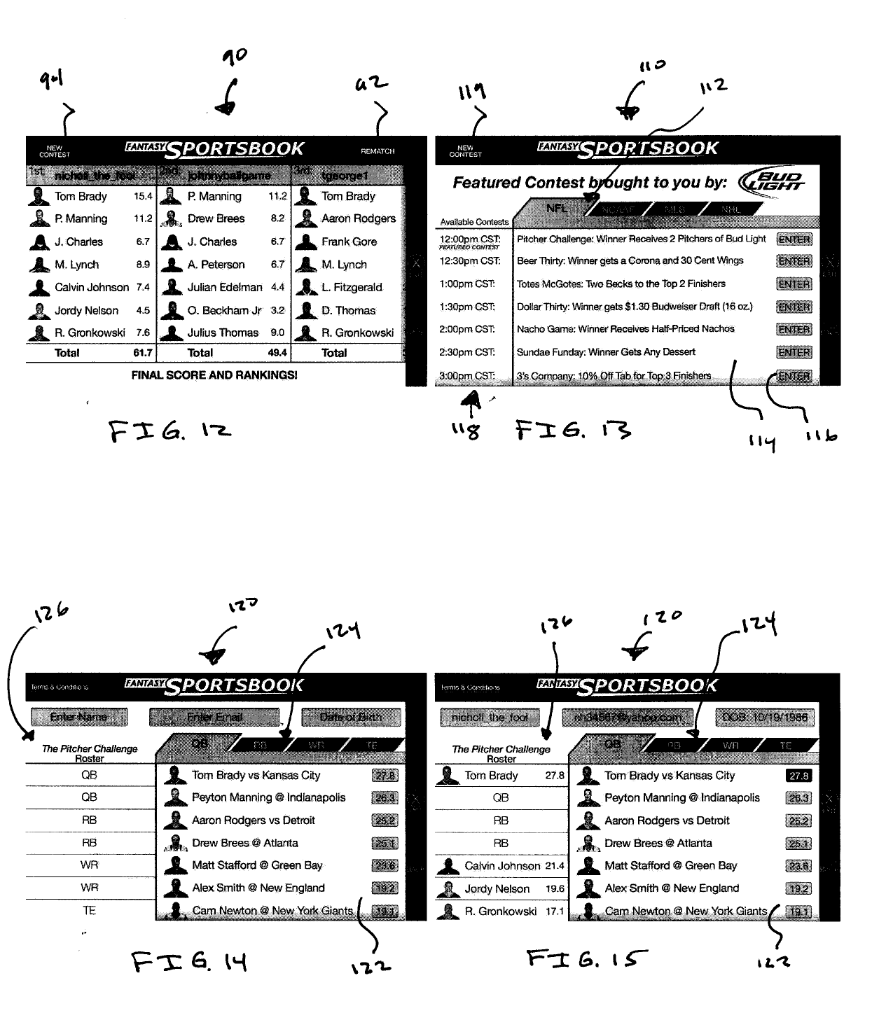

FIG. 13 shows an interface 110 corresponding to actuation of the public contests icon 100 in the main interface 40. The interface 110 displays one or more predefined fantasy contests in a module 114 having set start times 118. The predefined fantasy contests may be organized according to an associated sport via tabs 112, for example. In one embodiment, a player-user may select one of the predefined fantasy contests by actuating a corresponding actuation button 116. In one embodiment, a button 119 may be provided so that the player-user may set up a fantasy contest rather than select from the predefined public contests such as through the interface 52 shown as exemplary in FIG. 5.

Upon selection of a predefined public contest, a player-user is directed to an interface 120 for selecting fantasy players such as shown in FIGS. 14-16. As FIGS. 14-16 show, player-users may select fantasy players from a navigational window 122 having a plurality of selectable fantasy players. Tabs 124 may be available to assist fantasy player selection and to help navigate among categories of fantasy players, e.g., by position. Similar to above selection by the commissioner, the player-user must select a predefined quantity of fantasy players for a roster 126. As above, the roster 126 may function according to predefined game-play such as position-based selection criteria, e.g., a player-user must select one quarterback. Upon completing a full roster such as shown in FIG. 16, a user may actuate a control button 128 to submit the selections and team for participation in the fantasy contest. Various fields may be provided for team identification and tracking such as a team name, email address, and/or date of birth such as shown in FIGS. 14-16.

FIG. 17 shows an exemplary interface 140 for displaying statistical information to a user. The stats may be sortable and displayed by position and sports-type. In one embodiment, navigational actuation buttons may be provided to the user to initiate a new fantasy contest.

It is contemplated herein that the above fantasy game may be incorporated into different fantasy scoring algorithms, e.g., a home run is 1 point or 2 points, etc. and incorporated into different fantasy league types, e.g., tournament style involving multiple contests such as a round robin, single elimination, aggregate winning, etc. and is not intended to be limited thereby except as by the appending claims. Further, it is contemplated by this disclosure that odds may be factored into fantasy scoring and fantasy team scoring.

In various embodiments additional information associated with actual player projections may be displayed to the player-user at the selection stage or during the fantasy game. One or more statistical fields may be presented showing projected performance metrics including the projected fantasy performance metric. These projected points may be provided to fantasy players for informational purposes and/or to help aid in the selection of fantasy players.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. A fantasy game adapted to be played by a plurality of fantasy-players, said game comprising:
monitoring actual statistics and performance metrics of a plurality of sports-players participating in one or more sporting games;
time-stamping each statistic or player performance metric at a time the statistic or player performance metric was monitored;
defining qualifying statistics and player performance metrics for eligibility into a fantasy sports point system based upon the time-stamping of each of the statistics or player performance metrics; and
scoring the fantasy game based upon the qualifying statistics and performance metrics.

2. The fantasy game of claim 1, wherein the qualifying statistics and performance metrics are define as having a time-stamp within a time range.

3. The fantasy game of claim 1, wherein the qualifying statistics and performance metrics are defined being associated with a time-stamp within a user-specified time range.

4. The fantasy game of claim 3, wherein the user-specified time range is a time range less than associated with a game clock associated with the one or more sporting games.

5. The fantasy game of claim 1, wherein the time-stamping includes an hour parameter and a minute parameter.

6. The fantasy game of claim 1, further comprising:
iteratively storing, in a computer database, statistical performance data for a set of real-world athletes, wherein the real-world athletes are associated with a sports type;
receiving instructions from a user defining a fantasy season and type of fantasy game type;
receiving, from a client device of a user, a selection of real-world athletes from the set of real-word athletes, to be included in the fantasy-sports game associated with the user;
determining a fantasy score for each selected real-world athlete based upon real-world statistical performance data associated with the real-world athlete;
determining a total team fantasy score for the user, wherein the total team fantasy score is a sum of all the fantasy scores for each real-world athletes of the selection of real-world athletes; and
determining a winner of the fantasy-sports game, based on the total team fantasy scores and the selected game type.

7. The fantasy game of claim 6, further comprising:
awarding points, credits, or pecuniary compensation based upon the winner.

8. A computer-implemented method for operating a fantasy league using at least one fantasy server system, the method comprising:
monitoring actual statistics and performance metrics of a plurality of sports-players participating in one or more sporting games;
time-stamping each statistic or player performance metric at a time the statistic or player performance metric was monitored using at least an hour parameter and a minute parameter;
defining a time range for qualifying statistics and player performance metrics for accrual into a fantasy sports point system;
identifying statistics and player performance metrics having timestamps within the defined time range; and
scoring the fantasy game based upon the identified statistics and performance metrics.

9. The method of claim 8, wherein the defining qualifying statistics and player performance metrics is executed independent of game segments.

10. The method of claim 8, further comprising:
iteratively storing, in a computer database, statistical performance data for a set of real-world athletes, wherein the real-world athletes are associated with a sports type;
receiving instructions from a user defining a fantasy season and type of fantasy game type;
receiving, from a client device of a user, a selection of real-world athletes from the set of real-word athletes, to be included in the fantasy-sports game associated with the user;
determining a fantasy score for each selected real-world athlete based upon real-world statistical performance data associated with the real-world athlete;
determining a total team fantasy score for the user, wherein the total team fantasy score is a sum of all the fantasy scores for each real-world athletes of the selection of real-world athletes; and
determining a winner of the fantasy-sports game, based on the total team fantasy scores and the selected game type.

11. A computer-implemented method for operating a fantasy league, the method comprising:
receiving actual statistics and performance metrics of the plurality of sports-players participating in the one or more sporting games, wherein each statistic and performance metric includes timestamp data;
identifying whether the actual statistics and performance metrics has timestamp data formatted in Coordinated Universal Time (UTC) format or non-UTC format;
converting the timestamp data from the non-UTC format to a UTC time format based on an identification that the actual statistics and performance metrics has timestamp data formatted in the non-UTC format; and
defining a time range for qualifying statistics and player performance metrics for accrual into a fantasy sports point system;
identifying statistics and player performance metrics having timestamps within the defined time range; and
scoring the fantasy game based upon the identified statistics and performance metrics.

12. The method of claim 11, further comprising: providing predetermined countdown time-periods selectable by a user.

13. The method of claim 11, wherein the scoring is further executed based upon a rotisserie scoring scheme.

14. The method of claim 11, further comprising:
executing a fantasy game-type comprising one of a single player, a multi-player in head-to-head style, or a multi-player in a tournament style.

15. Method for operating a fantasy-sports game, the method comprising:
iteratively storing, in a computer database, statistical performance data for a set of real-world athletes, wherein the real-world athletes are associated with a plurality of sports types;
time-stamping each statistic or player performance metric at a time the statistic or player performance metric was monitored;
defining qualifying statistics and player performance metrics for accrual into a fantasy sports point system based upon the time-stamp associated with the statistic and player performance metric;
computing using a computer processor, for each real-world athlete, a projected point value corresponding to the projected performance of each real-world athlete, wherein the projected point value is normalized for comparison across the plurality of sports;
receiving instructions from a user defining a fantasy season and type of fantasy game type;
receiving, from a client device of a user, a selection of real-world athletes from the set of real-word athletes, to be included in the fantasy-sports game associated with the user, wherein each selected real-world athlete is associated with an individual projected point value;
determining a fantasy score for each selected real-world athlete based upon real-world statistical performance data associated with the real-world athlete;
determining a difference between the projected point value associated with the real-world athlete and the fantasy score;
determining a total team fantasy score for the user based upon the difference between the projected point value associated with the real-world athlete and the fantasy score, wherein the total team fantasy score is a sum of all the determined differences for each of the selected athletes; and
determining a winner of the fantasy-sports game, based on the total team fantasy scores and the selected game type.

16. The method of claim 15, wherein the projected point value associated with the real-world athlete is dynamically adjusted based upon user based activity.

17. The method of claim 15, further comprising:
awarding points, credits, or pecuniary compensation based upon a money line associated with the projected point value associated with the real-world athlete.

18. The method of claim 15, wherein the money line associated with the real-world athlete is dynamically adjusted based upon user based activity.
